(19) United States
(12) Patent Application Publication
(10) Pub. No.: US 2017/0206317 A1
(43) Pub. Date: Jul. 20, 2017

(54) SYSTEMS AND METHODS FOR TARGETED RADIOLOGY RESIDENT TRAINING

(71) Applicant: MEDSTAR HEALTH, Columbia, MD (US)

(72) Inventors: Raj Ratwani, Arlington, VA (US); Allan Fong, Arlington, VA (US); Ross Filice, Washington, DC (US); Arman Cohan, Washington, DC (US); Luca Soldaini, Washington, DC (US); Nazli Goharian, Chevy Chase, MD (US); Ophir Frieder, Chevy Chase, MD (US)

(21) Appl. No.: 15/410,850

(22) Filed: Jan. 20, 2017

Related U.S. Application Data
(60) Provisional application No. 62/280,883, filed on Jan. 20, 2016.

(51) Int. Cl. G06F 19/00

(52) U.S. Cl. CPC G06F 19/321; G06F 19/3406

(57) ABSTRACT

A system that can be used for targeted radiology resident training can include a memory storing computer-executable instructions and a processor to access the memory and execute the computer-executable instructions to at least receive a preliminary report and a corresponding final report; determine a difference between the final radiology report and the preliminary radiology report; classify the difference as substantive or stylistic based on a property of the difference; and produce an output including the difference when classified as substantive. The output can include one or more critical errors reflected in the substantive difference. The one or more critical errors can be used to facilitate radiology resident training.

### RELATED APPLICATIONS

This application claims the benefit of U.S. Provisional Application No. 62/280,883, entitled “SYSTEMS AND METHODS FOR IDENTIFYING CRITICAL ERRORS THAT CAN BE USED FOR TARGETED RADIOLOGY RESIDENT TRAINING,” filed Jan. 20, 2016. The entirety of this application is hereby incorporated by reference for all purposes.

### TECHNICAL FIELD

The present disclosure relates generally to targeted radiology resident training and, more specifically, to systems and methods for identifying critical errors in preliminary radiology reports that can be used for targeted training.

### BACKGROUND

When a medical imaging study of a patient is taken, a radiology resident first interprets the medical image and authors a preliminary radiology report. An attending radiologist then reviews and revises the preliminary radiology report and produces a final radiology report. Sometimes, the attending radiologist makes stylistic revisions to the preliminary radiology report. Other times, however, the attending radiologist disagrees with the first interpretation of the medical image and makes substantive revisions to the preliminary radiology report. These substantive revisions may be due to a critical interpretation error made by the radiology resident. Accordingly, distinguishing substantive revisions to the preliminary radiology report from stylistic changes may help the radiology resident focus on those reports where critical interpretation errors may have occurred and avoid such critical interpretation errors in the future. However, due to the large volume of final radiology reports, identifying these substantive changes can be challenging.

In previous computer-based solutions, revisions have been identified based on a threshold number of words differing between the preliminary radiology report and the final radiology report. However, these previous computer-based solutions have been unable to distinguish between revisions involving stylistic changes and substantive changes reliably. In fact, the previous computer-based solutions may miss some substantive changes that fall below the threshold number of words.

### SUMMARY

The present disclosure relates generally to targeted radiology resident training and, more specifically, to systems and methods for identifying critical errors in preliminary radiology reports that can be used for targeted training. A preliminary radiology report reflects a first pass at image interpretation drafting by a resident radiologist. An attending radiologist finalizes the preliminary radiology report into a final radiology report, making changes as necessary. Some of the changes may be non-substantive revisions that are non-critical. An example non-substantive change can be a stylistic change due to differences in reporting style between the radiology resident and the attending radiologist. However, other changes may be substantive revisions related to one or more critical errors related to erroneous image interpretation. These substantive revisions are important for the radiology resident to review and understand. Accordingly, the systems and methods of the present disclosure can distinguish between the substantive revisions reflecting critical errors and the non-substantive revisions. The critical errors can be used for targeted training, helping the radiology resident avoid such critical interpretation errors in the future.

In one example, the present disclosure includes a system that identifies substantive revisions made to a preliminary radiology report that can be used for targeted radiology resident training. The system can include a memory storing computer-executable instructions. The system can also include a processor to access the memory and execute the computer-executable instructions to at least: receive a preliminary radiology report related to an image of a patient and a corresponding final radiology report related to the image of the patient; identify a difference between the final radiology report and the preliminary radiology report based on a comparison between the preliminary radiology report and the corresponding final radiology report; classify the difference as significant or non-significant based on a property of the difference; and produce an output comprising the difference when classified as significant. The output can be used to facilitate the radiology resident training.

In another example, the present disclosure includes a method for identifying substantive revisions made to a preliminary radiology report that can be used for targeted radiology resident training. Steps of the method can be executed by a system comprising a processor. A preliminary radiology report related to an image of a patient and a corresponding final radiology report related to the image of the patient can be received. A difference between the final radiology report and the preliminary radiology report can be determined. The difference can be classified as substantive or non-substantive based on a property of the difference. An output including at least one difference classified as substantive can be produced. The output can be used to facilitate the radiology resident training.

In a further example, the present disclosure includes a non-transitory computer readable medium having instructions stored thereon that, upon execution by a processor, facilitate the performance of operations for identifying substantive revisions made to a preliminary radiology report. The operations comprise: receiving a preliminary radiology report related to an image of a patient and a corresponding final radiology report related to the image of a patient; determining a difference between the final radiology report and the preliminary radiology report based on a comparison between the preliminary radiology report and the corresponding final radiology report; classifying the difference as significant or non-significant based on a property of the difference; and producing an output including the difference when classified as significant. The output can be used to facilitate radiology resident training through the critical errors within the significant differences.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is an illustration of a system that can identify substantive revisions made to a preliminary radiology report that can be used for targeted radiology resident training in accordance with an aspect of the present disclosure;

FIG. 2 is an illustration of an example operation that can be performed by the system shown in FIG. 1;

FIG. 3 is a process flow diagram illustrating a method for identifying substantive revisions made to a preliminary radiology report that can be used for targeted radiology resident training in accordance with another aspect of the present disclosure;

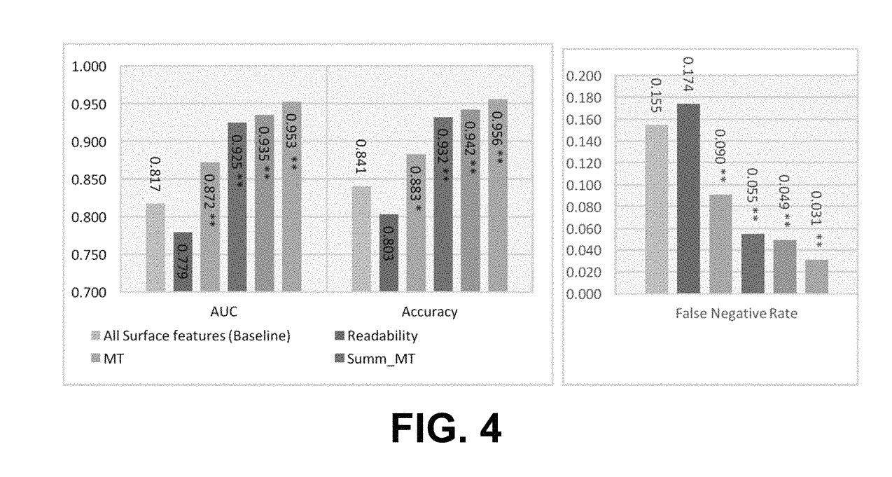

FIG. 4 shows classification results for different feature sets used to identify substantive revisions made to a preliminary radiology report;

FIG. 5 shows a comparison between different learning algorithms used to identify substantive revisions made to a preliminary radiology report; and

FIGS. 6A and 6B show Receiver Operating Characteristic (ROC) plots for different classifiers used to identify substantive revisions made to a preliminary radiology report.

### DETAILED DESCRIPTION

### I. Definitions

In the context of the present disclosure, the singular forms “a,” “an” and “the” can also include the plural forms, unless the context clearly indicates otherwise.

The terms “comprises” and/or “comprising,” as used herein, can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the terms “substantive” and “significant”, when referring to a revision, change, or difference, can refer to an important or meaningful change. For example, a substantive change from a preliminary radiology report made by an attending in a final radiology report is often due to a critical error made by the radiology resident in interpretation of a medical image.

As used herein, the terms “stylistic”, “non-substantive”, and “non-significant”, when referring to revision, change, or difference, can refer to a change related to writing style or format. In other words, a stylistic change from a preliminary report made by an attending in a final radiology report is often seen when the interpretation of the image made by the resident is not changed, but the writing style or format is changed in the final radiology report.

As used herein, the terms “preliminary radiology report”, “preliminary report” and “initial report” can be used interchangeably to refer to a written interpretation of a medical image prepared by a resident radiologist. In other words, the preliminary radiology report includes a rough draft interpretation of a medical image made by a resident radiologist.

As used herein, the terms “final radiology report” and “final report” can refer to an official written interpretation of a medical image prepared and/or authorized by an attending radiologist. As an example, the attending radiologist can revise a preliminary radiology report substantively and/or stylistically in the final radiology report.

As used herein, the term “radiology” can refer to a medical specialty for the interpretation of medical images to diagnose and/or treat one or more diseases.

As used herein, the term “medical image” can refer to a structural and/or functional visual representation of a portion of the interior of a patient's body. In some instances, the medical image can be a single visual representation of a portion of the interior of a patient's body (e.g., an x-ray image). In other instances, the medical image can include a plurality (e.g., a series) of visual representations of a portion of the interior of a patient's body (e.g., a computed tomography study, a magnetic resonance imaging study, or the like).

As used herein, the term “resident” can refer to can refer to a physician who practices medicine under the direct or indirect supervision of an attending physician. A resident receives in depth training within a specific specialty branch of medicine (e.g., radiology).

As used herein, the term “attending” can refer to a physician who has completed residency and practices medicine in a specialty learned during residency. The attending can supervise one or more residents either directly or indirectly.

As used herein, the term “evaluation metric”, or simply “metric”, can refer to a standard for quantifying something, often using statistics. For examples, different metrics can be used to quantify changes made to a preliminary radiology report as substantive or non-substantive.

As used herein, the term “automatic” can refer to a process that is accomplished by itself with little or no direct human control. An example, an automatic process can be performed by a computing device that includes a processor and, in some instances, a non-transitory memory.

### II. Overview

The present disclosure relates generally to targeted radiology resident training and, more specifically, to systems and methods for identifying critical errors in preliminary radiology reports that can be used for targeted training. The systems and methods of the present disclosure can distinguish between substantive revisions, reflecting critical errors that can be used for targeted training, and non-substantive revisions made to a preliminary radiology report in a final radiology report. The identified substantive revisions can be used for targeted radiology resident training by identifying areas that should be reviewed by the radiology resident in close detail. The goal of such targeted radiology training is to allow the resident to learn from their own interpretation errors to mitigate these errors in the future.

Prior techniques have been able to identify the existence of a revision between the primary radiology report and the final radiology report; for example, based on the number of words differing between the initial report and the final report. However, these prior techniques have been unable to identify the type of revision, so substantive and non-substantive revisions have both been identified. Advantageously, the systems and methods described herein can distinguish between revisions that are substantive and those that are merely stylistic. For example, the substantive revisions and non-substantive revisions can be identified by first identifying the difference between the final radiology report and the preliminary radiology report, and then classifying the difference as either a substantive revision, reflecting one or more critical errors, or a non-substantive revision. The critical errors identified as substantive revisions can be displayed for targeted radiology resident training.

### III. Systems

One aspect of the present disclosure can include a system 10 that can automatically identify substantive revisions made to a preliminary radiology report (prepared by a resident) in a final radiology report (revised and finalized by an attending). These substantive revisions can identify critical image interpretation errors that can be used for targeted radiology resident training. The system 10 can distinguish between significant and non-significant or stylistic difference.

As an example, the system 10 may be embodied on one or more computing devices that include a non-transitory memory 12 and a processor 14. In some instances, one or more of an input 16, a comparator 18, a classifier 20, and an output 22 can be stored in the non-transitory memory 12 as computer program instructions that are executable by the processor 14. Additionally, in some instances, the non-transitory memory 12 can store data related to the preliminary report (PR) and the corresponding final report (FR) and/or temporary data related to the preliminary report and the corresponding final report

The non-transitory memory 12 can include one or more non-transitory medium (not a transitory signal) that can contain or store the program instructions for use by or in connection with identifying substantive revisions made to a preliminary radiology report in a final radiology report. Examples (a non-exhaustive list) of non-transitory media can include: an electronic, magnetic, optical, electromagnetic, solid state, infrared, or semiconductor system, apparatus or device. More specific examples (a non-exhaustive list) of non-transitory media can include the following: a portable computer diskette; a random access memory; a read-only memory; an erasable programmable read-only memory (or Flash memory); and a portable compact disc read-only memory. The processor 14 can be any type of device (e.g., a central processing unit, a microprocessor, or the like) that can facilitate the execution of the computer program instructions to perform one or more actions of the system 10.

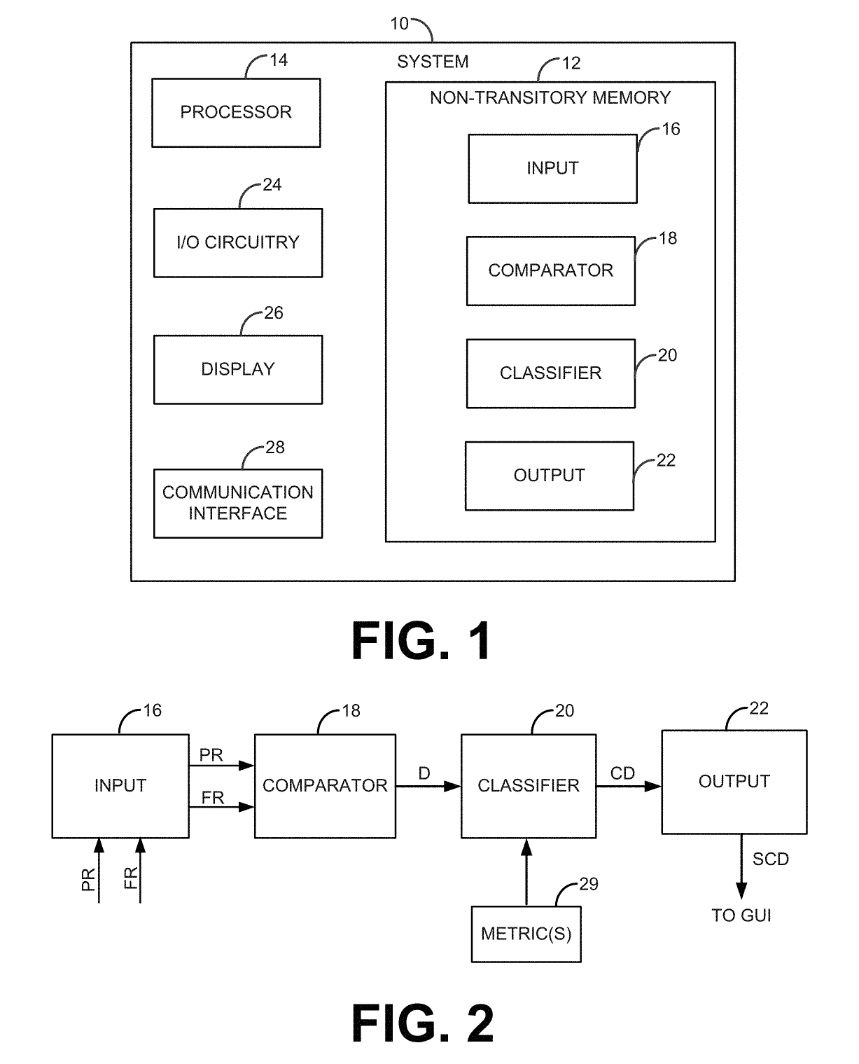

The system 10 can include input/output (I/O) circuitry 24 configured to communicate data with various input and output devices coupled to the system 10. In the example of FIG. 1, the I/O circuitry 24 facilitates communicate with the display 26 (which can include a graphical user interface (GUI) or other means to display an output to facilitate radiology resident training), an external input device, and/or a communication interface 28. For example, the communication interface 28 can include a network interface that is configured to provide for communication with corresponding network, like a local area network or a wide access network (WAN) (e.g., the internet or a private WAN) or a combination thereof. In some examples, the input 16 and/or the output 22 can be part of and/or interface with the I/O circuitry 24.

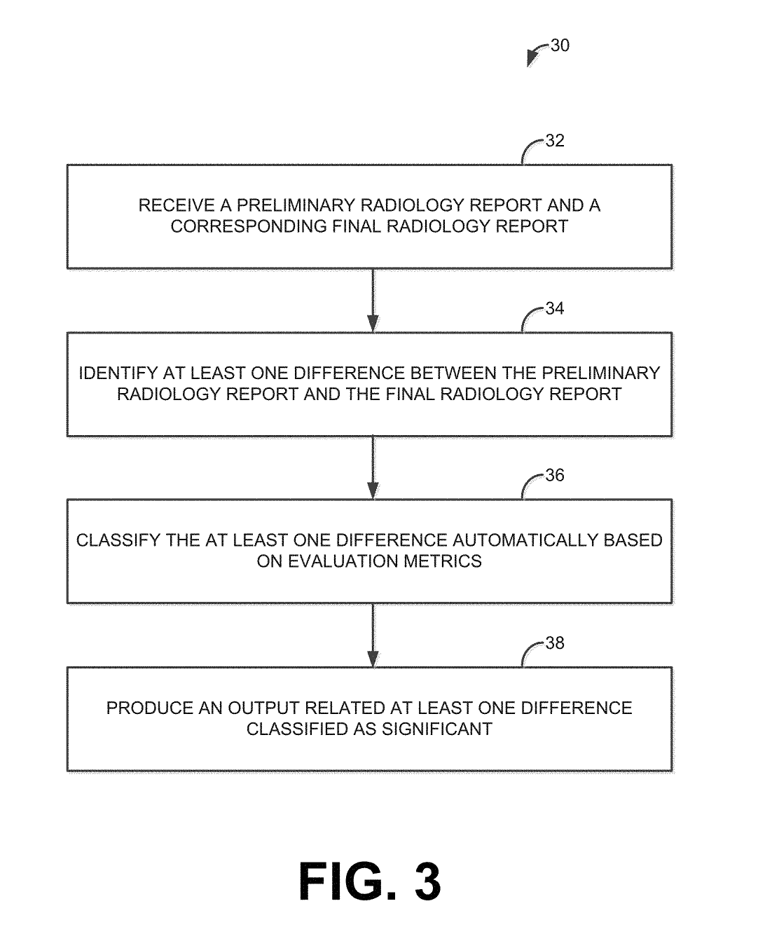

A simplified illustration of the operation of the input 16, comparator 18, classifier 20, and output 22 when executed by the processor 14 is shown in FIG. 2. The input 16 can receive a preliminary radiology report (PR) and a corresponding final radiology report (FR). As an example, the preliminary report (PR) and corresponding final radiology report (FR) can be retrieved from a central database that stores different instances of historical radiology reports. As another example, the preliminary radiology (PR) report and corresponding final radiology report (FR) can be stored, either temporarily or permanently, in a local non-transitory memory (e.g., non-transitory memory 12). In still another example, the preliminary radiology report (PR) and corresponding final radiology report (FR) can be received as an input from an input device, such as a scanner, a keyboard, a mouse, or the like.

The input 16 can send the received preliminary radiology report (PR) and corresponding final radiology report (FR) to the comparator 18, which determines or identifies at least one difference (D) between the final radiology report (FR) and the preliminary radiology report (PR). For example, the comparator 18 can use the final radiology report (FR) as a standard and compare the preliminary radiology report (PR) to the standard to identify the at least one difference. The comparator 18 sends the identified difference to the classifier 20, which classifies the identified difference as significant or non-significant based on a property of the difference. The property of the difference can be, for example, a comparison of overlap between the preliminary radiology report and the final radiology report and/or a comparison of sequence differences in the preliminary radiology report and the final radiology report.

In some instances, the classifier 20 can perform a binary classification of the identified differences so that each difference is labeled either as significant or stylistic (non-significant). In some instances, the classifier 20 provide a more detailed classification, taking into account multiple levels of significance based on an impact of a certain change on patient management to provide a multi-level classification. It will be understood that the comparator 18 and the classifier 20 can operate in conjunction as either separate elements or a single element. In some instances, the classifier 20 can also determine a level of significance based on an impact of the difference on a patient management characteristic. For example, a difference corresponding to a size of a tumor may be less significant than a difference corresponding to a presence of a tumor.

The classifier 20 can be trained according to one or more learning algorithms (e.g., an AdaBoost classifier, a Logistic regression classifier, a support vector machine (SVM) classifier, a Decision Tree classifier, or the like) trained on one or more evaluation metrics 29. In some instances, the learning algorithm can include a linear classifier algorithm. In other instances, the learning algorithm can include an AdaBoost boosting scheme and a Decision Tree base classifier. The learning algorithm of the classifier 20 can be trained on one or more evaluation metrics 29, such as surface textual features, summarization evaluation metrics, machine translation evaluation metrics, and readability assessment scores. The significance of the difference (or the level of significance of the difference) can be based on at least one of precision scores, recall scores, and longest common subsequence scores using a bi-lingual evaluation understudy comparison metric, a word error rate comparison metric, a readability assessment metric, or the like.

In some instances, the learning algorithm can be trained on summarization evaluation metrics and machine translation evaluation metrics. The summarization evaluation metrics can employ various automated evaluation metrics to compare overlap between the preliminary radiology report and the final radiology report and/or compare sequence differences in the preliminary radiology report and the final radiology report. In other words, the summarization evaluation metrics can identify differences between the preliminary report and the final report and may, in some instances, be used by the comparator 18.

The differences can be evaluated by the classifier 20 based on precision scores, recall scores, longest common subsequence scores, and the like. The machine translation evaluation metrics can be employed by the classifier 20 to capture the significance of the differences (and, therefore, identify substantive differences). For example, the significance can be determined by employing a bi-lingual evaluation understudy comparison metric and/or a word error rate comparison metric. In other instances, the evaluation metrics 29 can include summarization evaluation metrics, machine translation evaluation metrics, and readability assessment metrics. The readability assessment metrics account for a reporting style as related to using different average word and sentence lengths, different stylistic properties, or grammatical voice (to enable the classifier 20 to determine stylistic changes).

The classifier 20 can pass the classified difference (CD) to the output 22. Based on the classified difference, the output 24 can produce an output identifying significant differences, which are likely to correspond to errors in medical image interpretation. A resident can use the output for education with the goal of mitigating these errors. In some instances, the output 24 can disregard differences classified as stylistic. In some instances, significant classified differences (SCD) the output 24 can be displayed on a GUI so to be perceived by a radiology resident and used for targeted radiology resident training. The GUI can be located remote or local to the system 10 (e.g., as part of the display 26). In other instances, the significant classified differences (SCD) can be stored (e.g., in a non-transitory memory 12, a central database, or the like) for later targeted radiology training. In some instances, the displayed significant classified differences (SCD) can also include an indication of the level of significance of each of the significant classified differences (e.g., the significance can be portrayed in text, color, sound, or the like). The targeted radiology training can identify critical aspects of a medical image that the radiology resident may have missed and identify an overall learning trajectory for the radiology resident.

### IV. Methods

Another aspect of the present disclosure can include a method 30 for identifying substantive revisions made to a preliminary radiology report in a final radiology report that can be used for targeted radiology resident training. The acts or steps of the method 30 can be implemented by computer program instructions that are stored in a non-transitory memory and provided to a processor of a general purpose computer, special purpose computer, and/or other programmable data processing apparatus to produce a machine, such that the instructions, which execute via the processor, create mechanisms for implementing the steps/acts specified in the flowchart blocks and/or the associated description. In other words, the processor can access the computer-executable instructions that are stored in the non-transitory memory. As an example, the method can be executed by the system 10 of FIG. 1 by the components shown in FIG. 2.

The method 30 is illustrated as a process flow diagram as a flowchart illustration. For purposes of simplicity, the method 30 is shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the method 30.

At 32, a preliminary radiology report (e.g., PR) and a corresponding final radiology report (e.g., FR) can be received (e.g., to an input 16). As an example, the preliminary radiology report and corresponding final radiology report can be retrieved from a central database that stores different records of radiology reports. As another example, the preliminary radiology report and corresponding final radiology report can be stored in a local non-transitory memory (e.g., non-transitory memory 12). In still another example, the preliminary radiology report and corresponding final radiology report can be received as an input (e.g., from an input device, such as a scanner, a keyboard, a mouse, or the like).

At 34, at least one difference (e.g., D) between the preliminary radiology report and the final radiology report can be identified (e.g., by comparator 18). At 36, the at least one difference can be classified (e.g., by classifier 20) automatically based on evaluation metrics (e.g., metric(s) 29). The classification can be based on a classifier algorithm trained on the evaluation metrics. The classifier algorithm can employ, for example, an AdaBoost classifier, a Logistic regression classifier, a support vector machine (SVM) classifier, and/or a Decision Tree classifier. Additionally, the metrics can include one or more of surface textual features, summarization evaluation metrics, machine translation metrics, and readability assessment metrics.

In some instances, the classification can be based on a property of the difference. As an example, the property of the difference can be related to an impact of the difference on an aspect or a characteristic of patient management. The classifier algorithm trained on the evaluation metrics can determine whether the difference is significant or insignificant based on the aspect or characteristic of patient management. In some instances, the classification can be further based on a level of significance. The level of significance can be determined based on an impact of the difference on a characteristic corresponding to an aspect of patient management. In some instances, a determination of significant/not-significance and/or the level of significance can be determined based on significance of the difference based on at least one of precision scores, recall scores, and longest common subsequence scores, a bi-lingual evaluation understudy comparison metric, a word error rate comparison metric, and a readability assessment metric.

In some instances, the identification and classification of the at least one difference can be accomplished as a single step. For example, the at least one difference can be classified as significant or stylistic by leveraging different sets of textual features. For example, the textual features can include one or more of surface textual features, summarization evaluation metrics, machine translation evaluation metrics, and readability assessment scores. In another example, the textual features can include summarization evaluation metrics and machine translation evaluation metrics. The summarization evaluation metrics can compare overlap between the preliminary report and the final report and/or compare sequence differences in the preliminary report and the final report. The machine translation evaluation metrics can quantify the quality of a preliminary report with respect to the final report to capture the significance of the differences. The classification can be based on a classifier algorithm trained to the specific textual features that are to be used. For example, the classifier algorithm can be trained on the summarization evaluation metrics and the machine translation evaluation metrics. The classifier algorithm can employ an AdaBoost classifier, a Logistic regression classifier, a support vector machine (SVM) classifier, or a Decision Tree classifier, for example. In some instances, the classifier algorithm can employ an AdaBoost classifier and a Decision Tree classifier.

The classification can provide a binary classification, for example: the at least one difference can be classified as either a significant change or a stylistic (non-significant) change. In some instances, the classification can take into account multiple levels of significance based on an impact of a certain change on patient management. As an example, the classification of a significant change can be used to identify critical errors in a resident's preliminary radiology report. For example, the critical errors can correspond to certain findings that may have been missed in a medical image.

At 38, an output can be produced (e.g., by output 24) related to at least one difference classified as significant. The output can also include, in some instances, an indication of the level of significance. In some instances, the output can identify common significant problems in preliminary reports automatically with the goal of detecting common errors and mitigating these errors. For example, the output can show one or more systemic changes corresponding to a critical error in the preliminary report made in the corresponding final report. In this example, the output may not show any of the changes classified as stylistic. In some instances, the output can be displayed (e.g., on a GUI of display 26) so to be perceived by a radiology resident and used for targeted radiology resident training. In other instances, the output can be stored (e.g., in a non-transitory memory 12, a central database, or the like) for later targeted radiology training. The output can be used to facilitate radiology resident training, allowing radiology residents to focus on critical errors in image interpretation. Additionally, the output can be used to monitor a particular resident radiologist and identify overall learning trajectories of a particular resident radiologist, which can be used to design a targeted learning program for the particular resident radiologist.

### V. Example

This example, for the purpose of illustration only, shows a classification scheme that automatically distinguishes between significant and non-significant discrepancies found in final radiology reports compared to preliminary radiology reports.

### Methods

To differentiate significant and non-significant discrepancies in radiology reports, a binary classification scheme was proposed that leverages different sets of textual features. The different sets of textual features can include, for example, surface textual features, summarization evaluation metrics, machine translation evaluation metrics, and readability assessment scores.

Surface Textual Features

Previous work used word count discrepancy as a measure for quantifying the differences between preliminary and final radiology reports. This experiment uses an improved version of the aforementioned technique as the baseline. That is, in addition to the word count differences, the character and sentence differences between the two reports are also considered as an indicator of significance of changes.

Summarization Evaluation Features

Manually evaluating the quality of automatic summarization systems is a long and exhausting process. Thus, various automatic evaluation metrics that address this evaluation problem have been proposed. ROUGE, one of the most widely used set of metrics; estimates the quality of a system generated summary by comparing the summary with a set of human generated summaries.

Unlike the traditional use of ROUGE as an evaluation metric in summarization settings, ROUGE is exploited in this experiment as a feature for comparing the soundness of the preliminary report with respect to the final report. Both ROUGE-N and ROUGE-L are used in this experiment.

In this setting, ROUGE-N includes precision and recall scores by comparing the word n-gram overlap between the preliminary and final report, where N is the length of a word (e.g., N=1 indicates a single term, N=2 a word bigram, and so on). ROUGE-1 to ROUGE-4 is considered in this experiment.

ROUGE-L captures the sequence differences in the preliminary and final reports. Specifically, ROUGE-L calculates the Longest Common Subsequence (LCS) between the preliminary and the final report. Intuitively, longer LCS between the preliminary and the final report shows more similarity. Here, both ROUGE-L precision and ROUGE-L recall are considered.

Machine Translation (MT) Evaluation Features

The Machine Translation (MT) evaluation metrics quantify the quality of a system-generated translation against a given set of reference or gold translations. The final report is considered as the reference the quality of the preliminary report is evaluated against the final report. A higher score indicates a better quality of the preliminary report with respect to the final report, namely, the discrepancies between them are less significant. These MT evaluation metrics (BLEU and WER) are used as features to capture the significance of the difference between the preliminary report and the final report. BLEU and WER are both commonly used machine translation evaluation metrics that are used as features in the model.

BLEU (Bi-Lingual Evaluation Understudy)

BLEU is an n-gram based comparison metric for evaluating the quality of a candidate translation with respect to several reference translations (conceptually similar to ROUGE-N). BLEU promotes those automatic translations that share a large number of n-grams with the reference translation. Formally, BLEU combines a modified n-gram-based precision and a so-called “Brevity Penalty” (BP), which penalizes short candidate translations. The BLEU score of the preliminary report with respect to the final report is used in this experiment.

WER (Word Error Rate)

WER is another commonly used metric for the evaluation of machine translation. It is based on the minimum exit distance between the words of a candidate translation versus reference translations, considered as the following formula:

WER=100×((S+I+D)/N),

where N is the total number of words in the preliminary report, S, I, and D are the number of Substitutions (S), Insertions (I), and Deletions (D) made to the preliminary report to yield the final report.

Readability Assessment Features

Various readability assessment features were used to quantify the writing style and complexity of textual content. “Style” refers to the reporting style as it relates to using different average word and sentence lengths, different syntactic properties (e.g. different number of Noun/Verb Phrases), grammatical voice (active/passive), etc. In detail, the Gunning Fog index, Automated Readability Index (ARI) and the Simple Measure of Gobbledygook (SMOG) index were used. All of the aforementioned metrics are based on some distributional features such as the average number of syllables per word, the number of words per sentence, or binned word frequencies. Furthermore, average phrase counts (noun, verb and propositional phrases) were considered among the features.

The style of the report affects the readability of the report. This set of features was used to distinguish between the reporting style and readability of the preliminary and the final reports. However, grammatical voice (active and passive) did not change between the preliminary and final reports in our dataset. Since each of these metrics is effective in different domains and datasets, the metrics were combined to capture as many stylistic reporting differences as possible.

Learning Algorithm

Since a learning algorithm's performance varies based on conditions, several learning algorithms were evaluated to find the best performing learning algorithm. Specifically, the following classification algorithms were used in this experiment: Support Vector Machine (SVM) with linear kernel, Logistic Regression with L2 regularization, Stochastic Gradient Descent (SGD), Naïve Bayes, Decision Tree, Random Forest, Quadratic Discriminant Analysis (QDA), Nearest Neighbors, and AdaBoost with Decision Tree as the base classifier.

Data

A set of radiology reports from a large urban hospital were evaluated. The reports were produced using an electronic radiology reporting system and each record contains both the preliminary and the final version of the report. In the reporting template, sometimes the attending marks the report as a report with significant discrepancies between the final and the preliminary version. However, lack of this indication does not necessarily mean that the differences are insignificant (annotated data for non-significant changes was not available).

The non-significant reports were labeled based on the following intuition: if the findings in two reports are not significantly different and the changes between them are not substantive, then there should be no difference in the radiology concepts in these reports. Thus, if the sets of radiology concepts are identical between the reports and also the negations are consistent, then the difference is non-significant. To find the differences in the radiology concepts, the RadLex ontology was used. More specifically, expressions were extracted from the reports that map to concepts in this ontology. To detect negations, the dependency parse tree of the sentences and a set of seed negation words (“not” and “no”) were used. In other words, a radiology concept was marked as negated, if these seed words are dependent on the concept.

TABLE 1
An example of the semi-supervised
labeling used for this experiment.

| Report # | 1 | 2 |
|---|---|---|
| Preliminary | Tiny calcific density projects | Active bleeding in the mid |
| Report | over the superior aspect of | to distal transverse colon |
| | the left renal shadow, for | corresponding to branches |
| | which calculus cannot be | of the middle colic artery. |
| | excluded. | |
| Final Report | Tiny calcific density projects | Possibly focus of active |
| | over the superior left renal | gastrointestinal bleeding in |
| | shadow, calculus cannot be | the descending colon. |
| | excluded. | |
| Observation | No difference between set | There is a difference |
| | of radiology concepts and | between radiology |
| | polarity. | concepts. |
| Assigned | Non-significant | No label |
| Label | | |

An example of this heuristic is shown in Table 1, in which the report on the left column is labeled as non-significant but the report on the right column is left without labels since it does not meet the two explained criteria. In the left report, the RadLex concepts and the negations are consistent across the preliminary and final report. The final dataset that we use in the evaluation consists of 2221 radiology reports, which consists of 965 reports that are manually labeled as significant, and 1256 reports that are labeled as non-significant using the labeling approach described above.

TABLE 2
Agreement among human annotators and the heuristic scheme.

| | |
|---|---|
| Agreement rate among annotators | 0.896 |
| Fleiss □ among annotators and the | 0.826 |
| heuristic scheme | |

To examine the quality of data obtained using this labeling scheme, 100 cases were randomly sampled from the dataset. Two annotators were asked to identify reports with non-significant discrepancies. The annotators were allowed to label a case as “not sure” if they could not confidently label the case as non-significant. The agreement rate between the annotators and the heuristic in determining non-significant cases is reported in Table 2. Notably, the Fleiss—agreement is above 0.8, signifying an almost perfect inter-annotator agreement.

### Results

A set of experiments were conducted to evaluate the effectiveness of the proposed classification approach.

Feature Analysis

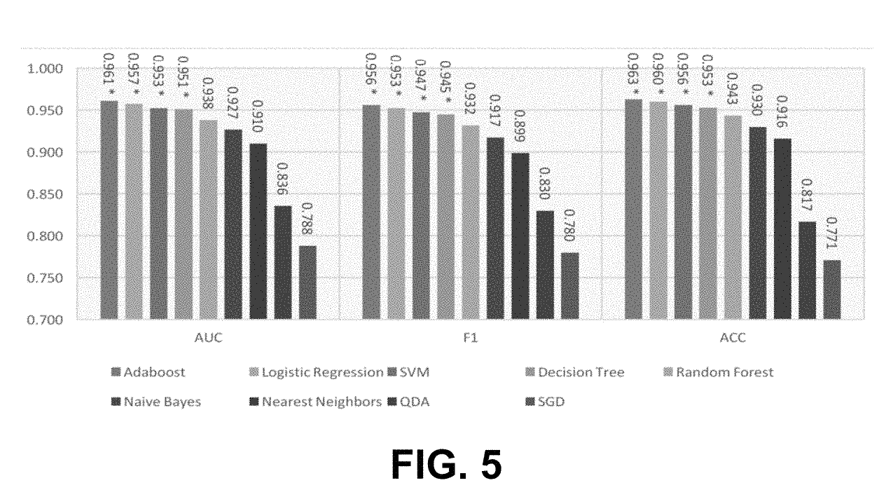

FIG. 4 shows the classification results using different sets of features (described above) using a SVM classifier. Specifically, the Area Under the Curve (AUC), accuracy, and false negative rate results for each set of features. The baseline combines the character, word, and sentence count differences, which achieves an accuracy of 0.841 and AUC of 0.817, a strong baseline.

Almost all of the proposed features outperform the baseline significantly. This shows the effectiveness of the proposed set of features including the summarization evaluation metrics and the machine transformation evaluation metrics. Interestingly, the readability features are the only set of features that perform worse than the baseline (AUC is −4.89%). The readability features mostly capture the differences between the reporting styles, as well as the readability of the written text. Such behavior can be attributed to style similarity of the preliminary and final report although the content differs. For example, some important radiology concepts relating to a certain interpretation might be contradictory in the preliminary and final report, while both reports follow the same style. Thus, readability features on their own are not able to capture significant discrepancies.

The summarization and machine translation features significantly improve performance over the baseline in terms of AUC (+14.4% and +6.7%, respectively). Features such as ROUGE, BLEU and WER outperform the surface textual features. However, summarization features perform better by themselves than when combined with machine translation features. On the other hand, when all features were used, including surface and readability features, the highest improvement (+16.7% AUC over the baseline) was seen. The combined features also outperform all other feature sets significantly. This is because each set of features is able to capture different aspects of report discrepancies. For example, adding readability features along with summarization and machine translation features additionally accounts for the reporting style nuances.

Due to the nature of the problem, reducing the false negative rate is an important metric in the evaluation of the system. The false negative rate essentially measures the rate at which the reports with significant changes are misclassified by the system. FIG. 4 also shows the evaluation results based on the false negatives. The proposed features (except for readability) effectively reduce the false negative rate. The lowest false negative rate (80.0% less than the baseline) is achieved when all features are utilized.

Comparison Between Classification Algorithms

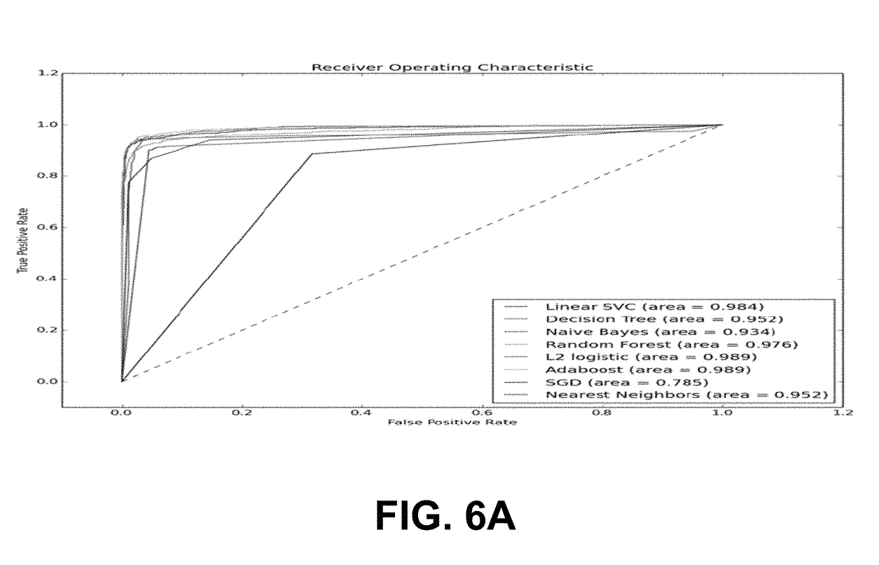

The performance of different classification algorithms was evaluated to find the most effective one for this problem. In FIG. 5, the results per classifier trained on all features are illustrated. The differences between the classifiers are not statistically significant among the top four performing classifiers. The highest area under the curve is achieved by the AdaBoost, Logistic regression, linear SVM, and Decision Tree classifiers, respectively. The worst performing classifier is the Stochastic Gradient Descent (SGD) function. While SGD is very efficient for large scale datasets, its performance might be less optimal than deterministic optimization algorithm as it optimizes the loss function based on randomly selected samples, rather than the entire dataset.

The QDA and Naïve Bayes are the next lowest performing classifiers. This is attributed to the fundamental feature independence assumption in these classifiers, whereas some of the features are correlated with each other.

The linear classifiers outperform the others, which demonstrates that the feature space is linearly separable. AdaBoost achieves the highest scores among all the classifiers. AdaBoost is a boosting scheme that uses a base classifier to predict the outcomes, iteratively increases the weights of those instances incorrectly classified by the base classifier. Here, AdaBoost was paired with a Decision Tree classifier. By learning from incorrectly classified examples, AdaBoost can effectively improve the Decision Tree performance.

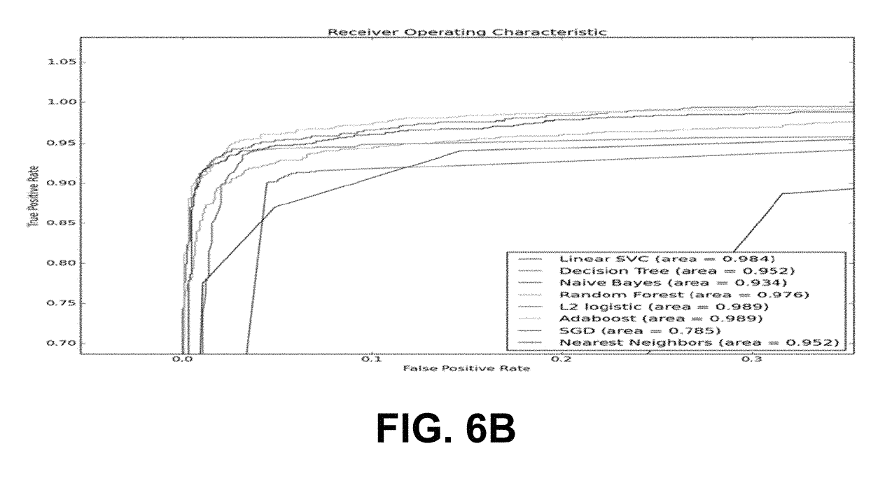

The same patterns can be observed in Receiver Operating Characteristic (ROC) curves of the classifiers (FIGS. 6A and 6B). FIG. 6A shows the full ROC plot, while FIG. 6B shows a zoomed in view of the top of the ROC curve.

The results show that two out of three proposed features—text summarization and machine translation evaluation features—are significantly more effective than the baseline features of character, word, and sentence level differences. When the summarization and machine translation evaluation features were combined with readability features, the highest accuracy was achieved. The results show that the feature space is suitable for both linear and decision tree based classifiers.

From the above description, those skilled in the art will perceive improvements, changes and modifications. Such improvements, changes and modifications are within the skill of one in the art and are intended to be covered by the appended claims.

What is claimed is:

1. A system comprising:
a memory storing computer-executable instructions; and
a processor to access the memory and execute the computer-executable instructions to at least:
receive a preliminary radiology report related to an image of a patient and a corresponding final radiology report related to the image of the patient;
identify a difference between the final radiology report and the preliminary radiology report;
classify the difference as significant or non-significant based on a property of the difference; and
produce an output comprising the difference when classified as significant.

2. The system of claim 1, further comprising a graphical user interface (GUI) to display the output to facilitate radiology resident training.

3. The system of claim 1, wherein the difference is identified based on a comparison between the preliminary radiology report and the final radiology report,
wherein the final radiology report is defined as a standard.

4. The system of claim 1, wherein the difference is classified as significant a level of significance is determined based on an impact of the difference on a patient management characteristic.

5. The system of claim 1, wherein the classification is performed by a classifier trained on one or more metrics,
wherein the classifier is at least one of an AdaBoost classifier, a Logistic regression classifier, a support vector machine (SVM) classifier, or a Decision Tree classifier.

6. The system of claim 5, wherein the one or more metrics comprise one or more of surface textual features, summarization evaluation metrics, machine translation metrics, and readability assessment metrics.

7. The system of claim 1, wherein the classification is based on a significance of the difference.

8. The system of claim 7, wherein the significance of the difference is based on at least one of precision scores, recall scores, and longest common subsequence scores.

9. The system of claim 7, wherein the significance of the difference is based on at least one of a bi-lingual evaluation understudy comparison metric or a word error rate comparison metric.

10. The system of claim 7, wherein the significance of the difference is based on a readability assessment metric.

11. The system of claim 1, wherein the difference is identified based on at least one of a comparison of overlap between the preliminary radiology report and the final radiology report and a comparison of sequence differences in the preliminary radiology report and the final radiology report.

12. A method comprising:
receiving, by a system comprising a processor, a preliminary radiology report related to an image of a patient and a corresponding final radiology report related to the image of a patient;
determining, by the system, a difference between the final radiology report and the preliminary radiology report based on a comparison between the preliminary radiology report and the corresponding final radiology report;
classifying, by the system, the difference as significant or non-significant based on a property of the difference; and
producing, by the system, an output including the difference when classified as significant.

13. The method of claim 12, wherein the difference is classified as significant, further comprising:
determining, by the system, a level of significance is determined based on an impact of the difference on a characteristic corresponding to an aspect of patient management,
wherein the output includes an indication of the level of significance and the difference.

14. The method of claim 12, further comprising displaying, by a device comprising a graphical user interface (GUI), the output to facilitate radiology resident training.

15. The method of claim 12, wherein the classifying is further based on a classifier algorithm trained on one or more metrics.

16. The method of claim 15, wherein the classifier algorithm employs an AdaBoost classifier, a Logistic regression classifier, a support vector machine (SVM) classifier, or a Decision Tree classifier.

17. The method of claim 15, wherein the one or more metrics are one or more of surface textual features, summarization evaluation metrics, machine translation metrics, and readability assessment metrics.

18. The method of claim 12, wherein the classifying further comprises:
determining a significance of the difference based on at least one of precision scores, recall scores, and longest common subsequence scores, a bi-lingual evaluation understudy comparison metric, a word error rate comparison metric, and a readability assessment metric; and
classifying the difference as significant or non-significant based on the determined significance.

19. A non-transitory computer readable medium having instructions stored thereon that, upon execution by a processor, facilitate the performance of operations, wherein the operations comprise:
receiving a preliminary radiology report related to an image of a patient and a corresponding final radiology report related to the image of a patient;
determining a difference between the final radiology report and the preliminary radiology report based on a comparison between the preliminary radiology report and the corresponding final radiology report;
classifying the difference as significant or non-significant based on a property of the difference; and
producing an output including the difference when classified as significant.

20. The non-transitory computer readable medium of claim 19, wherein the difference is classified as significant, the operations further comprising:
determining a level of significance is determined based on an impact of the difference on an aspect of patient management,
wherein the output includes an indication of the level of significance and the difference.
